(19) United States
(12) Patent Application Publication
(10) Pub. No.: US 2025/0289237 A1
(43) Pub. Date: Sep. 18, 2025

(54) PRINTING UNIT AND RECORDING APPARATUS

(71) Applicant: KYOCERA CORPORATION, Kyoto-shi, Kyoto (JP)

(72) Inventors: Daisuke ETO, Nishi-ku, Osaka-shi, Osaka (JP); Masaaki MARUTA, Matsubara-shi, Osaka (JP); Masahiro HIGASHITANI, Taishi-cho, Minamikawachi-gun, Osaka (JP); Hiroatsu TAMAI, Chuo-ku, Osaka-shi, Osaka (JP)

(21) Appl. No.: 18/859,998

(22) PCT Filed: Apr. 11, 2023
(86) PCT No.: PCT/JP2023/014771

§ 371 Date: Oct. 25, 2024

(30) Foreign Application Priority Data
Apr. 27, 2022 (JP) 2022-073571

(51) Int. Cl. B41J 2/21; B41J 2/15

(52) U.S. Cl. CPC B41J 2/2103; B41J 2/2107; B41J 2/15

(57) ABSTRACT

A printing unit includes a carriage configured to reciprocate in a main scanning direction and a plurality of ink heads configured to discharge ink. The plurality of ink heads are mounted on the carriage to form a plurality of ink head columns, each of the plurality of ink head columns extends along the main scanning direction, the plurality of ink head columns are side by side in a sub scanning direction intersecting with the main scanning direction. The plurality of ink heads include a plurality of same-color ink head groups, each of the plurality of same-color ink head groups including a plurality of same-color ink heads configured to discharge ink of the same color. In at least one same-color ink head group, the plurality of same-color ink heads are disposed in a single ink head column.

### TECHNICAL FIELD

The present disclosure relates to a printing unit and a recording apparatus including an ink head mounted on a carriage that moves in a main scanning direction.

### BACKGROUND OF INVENTION

As an ink jet recording apparatus such as an ink jet printer, there is known an ink jet recording apparatus including a printing unit that performs printing on a recording medium. The printing unit includes an ink head that discharges ink for image formation toward a recording medium. When the recording medium has a large width, the ink head is mounted on a carriage that reciprocates in a main scanning direction. In printing, the recording medium is intermittently fed in a predetermined direction (sub scanning direction), and the ink is discharged from the ink head while the carriage is reciprocated in the main scanning direction while the recording medium is stopped.

Patent Document 1 discloses a technique in which a plurality of ink heads are disposed in a line along the main scanning direction. The plurality of ink heads include same-color ink heads that discharge ink of the same color.

### CITATION LIST

### Patent Literature

Patent Document 1: JP 2012-20536 A

### SUMMARY

A printing unit according to an aspect of the present disclosure includes a carriage configured to reciprocate in a main scanning direction and a plurality of ink heads configured to discharge ink. The plurality of ink heads are mounted on the carriage to form a plurality of ink head columns, each of the plurality of ink head columns extending along the main scanning direction, the plurality of ink head columns being arranged side by side in a sub scanning direction intersecting with the main scanning direction. The plurality of ink heads include a plurality of same-color ink head groups, each of the plurality of same-color ink head groups including a plurality of same-color ink heads configured to discharge ink of the same color. In at least one same-color ink head group of the plurality of same-color ink head groups, the plurality of same-color ink heads are disposed in one ink head column of the plurality of ink head columns and are not disposed in the other ink head columns.

A recording apparatus according to another aspect of the present disclosure includes the printing unit described above and a conveying portion configured to convey a recording medium along a conveyance direction parallel to the sub scanning direction.

### BRIEF DESCRIPTION OF THE DRAWINGS

FIG. 1 is a perspective view illustrating an overall configuration of an ink jet recording apparatus according to an embodiment of the present disclosure.

FIG. 2 is a schematic cross-sectional view taken along line II-II in FIG. 1.

FIG. 3 is an enlarged perspective view of a carriage illustrated in FIG. 1.

FIG. 4 is a schematic diagram illustrating a serial printing method adopted in an embodiment of the present disclosure.

FIG. 5A is a schematic diagram illustrating a printing state in a forward path and a backward path of the carriage.

FIG. 5B is a schematic diagram illustrating a printing state in the forward path and the backward path of the carriage.

FIG. 6 is a plan view schematically illustrating an arrangement of ink heads and processing heads on the carriage illustrated in FIG. 3.

FIG. 7 is a schematic plan view illustrating an arrangement of ink heads and processing heads on a carriage according to a first modified embodiment of the present disclosure.

FIG. 8 is a schematic plan view illustrating an arrangement of ink heads and processing heads on a carriage according to a second modified embodiment of the present disclosure.

FIG. 9 is a schematic plan view illustrating an arrangement of ink heads and processing heads on a carriage according to a third modified embodiment of the present disclosure.

### DESCRIPTION OF EMBODIMENTS

Hereinafter, a printing unit according to each embodiment of the present disclosure will be described with reference to the drawings. In these embodiments, as a specific example of an apparatus including a printing unit, an ink jet printer (recording apparatus) including an ink head which discharges ink for forming an image onto a wide and long recording medium will be exemplified. The ink jet printer is suitable for digital textile printing in which an image such as characters or a pattern is printed on a recording medium made of a fabric such as a woven fabric or a knitted fabric by an ink jet method. Of course, the printing unit according to the present disclosure can also be used for printing various images on a recording medium such as a paper sheet or a resin sheet.

### Overall Configuration of Ink Jet Printer

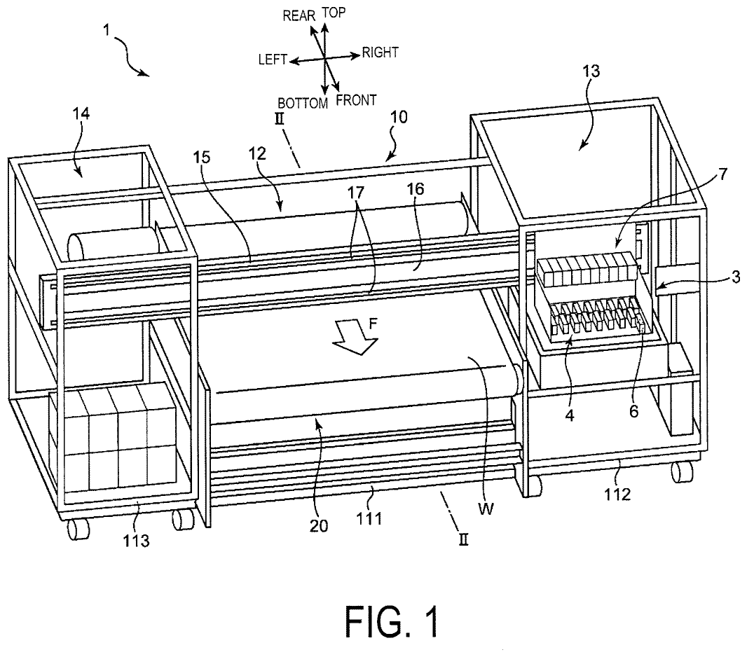

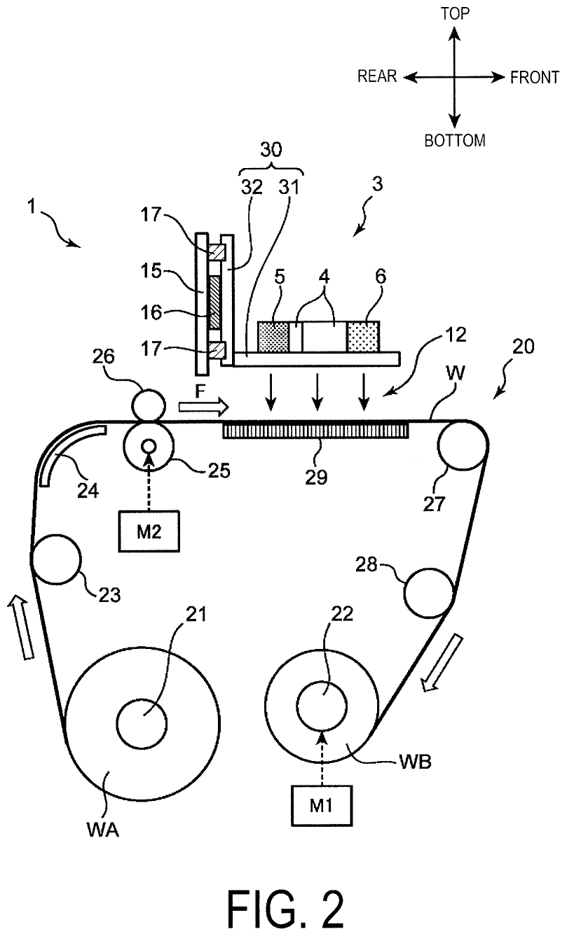

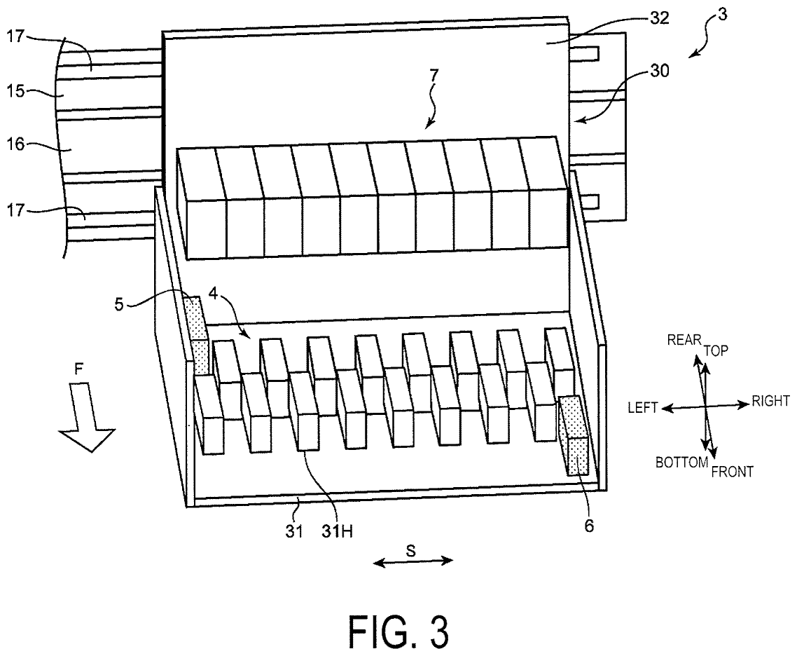

FIG. 1 is a perspective view illustrating an overall configuration of an ink jet printer 1 according to a first embodiment of the present disclosure, and FIG. 2 is a schematic cross-sectional view taken along line II-II in FIG. 1. The ink jet printer 1 is a printer that performs printing of an image on a wide and long workpiece W (recording medium) by an ink jet method, and includes a device frame 10, a workpiece conveying portion 20 (conveying portion) incorporated in the device frame 10, and a carriage 3. In the present embodiment, the left-right direction is a main scanning direction S (FIG. 3) during printing on the workpiece W, and the direction from the rear toward the front is a sub scanning direction (a conveyance direction F of the workpiece W that is a direction intersecting the main scanning direction S).

The device frame 10 forms a framework for mounting various constituent members of the ink jet printer 1. The workpiece conveying portion 20 is a mechanism that intermittently feeds (conveys) the workpiece W so that the workpiece W advances in the conveyance direction F from the rear to the front in a printing region where the ink jet printing processing is performed. The carriage 3 is mounted with an ink head 4, a pre-processing head 5, a post-processing head 6, and a sub-tank 7, and reciprocates in the main scanning direction S (left-right direction) intersecting the conveyance direction F of the workpiece W during the ink jet printing processing. The movable unit constitutes the printing unit of the present disclosure.

The device frame 10 includes a center frame 111, a right frame 112, and a left frame 113. The center frame 111 forms a framework on which various constituent members of the ink jet printer 1 are mounted, and has a left-right width corresponding to the workpiece conveying portion 20. The right frame 112 and the left frame 113 are erected on the right side and the left side of the center frame 111, respectively. A space between the right frame 112 and the left frame 113 is a printing area 12 in which the printing processing is executed on the workpiece W.

The right frame 112 forms a maintenance area 13. The maintenance area 13 is an area in which the carriage 3 is retracted when the printing processing is not executed. In the maintenance area 13, nozzles (discharge holes) of the ink heads 4, the pre-processing head 5, and the post-processing head 6 are subjected to cleaning processing, purging processing, and the like, and are capped. The left frame 113 forms a return area 14 of the carriage 3. The return area 14 is a region into which the carriage 3, which has main-scanned the printing area 12 from the right to the left in the printing processing, temporarily enters when performing the main scanning in the reverse direction.

A carriage guide 15 for causing the carriage 3 to reciprocate in the left-right direction is assembled on the upper side of the device frame 10. The carriage guide 15 is a flat plate shape member that is long in the left-right direction, and is disposed above the workpiece conveying portion 20. A timing belt 16 is attached to the carriage guide 15 so as to be capable of circumferential movement in the left-right direction (main scanning direction). The timing belt 16 is an endless belt and is driven so as to circulate in the left direction or the right direction.

The carriage guide 15 is provided with a pair of upper and lower guide rails 17 which hold the carriage 3 in a state where the carriage 3 can reciprocate in the main scanning direction S so as to extend in parallel in the left-right direction. The carriage 3 is engaged with the guide rails 17. The carriage 3 is fixed to the timing belt 16. The carriage 3 moves in the left direction or the right direction along the carriage guide 15 while being guided by the guide rails 17 as the timing belt 16 moves in a left or right circumferential direction.

Referring mainly to FIG. 2, the workpiece conveying portion 20 includes a feeding roller 21 feeding the workpiece W before printing and a winding roller 22 winding the workpiece W after printing. The feeding roller 21 is disposed at a rear lower portion of the device frame 10 and is a winding shaft of a feeding roll WA that is a wound body of the workpiece W before printing. The winding roller 22 is disposed at a front lower portion of the device frame 10 and is a winding shaft of a winding roll WB that is a wound body of the workpiece W after being subjected to the printing processing. A first motor M1 rotationally driving the winding roller 22 around the shaft and causing the winding roller 22 to execute a winding operation of the workpiece W is attached to the winding roller 22.

A path between the feeding roller 21 and the winding roller 22 and passing through the printing area 12 serves as a conveyance path of the workpiece W. In the conveyance path, a first tension roller 23, a workpiece guide 24, a conveyance roller 25 and a pinch roller 26, a return roller 27, and a second tension roller 28 are disposed in this order from the upstream side. The first tension roller 23 applies a predetermined tension to the workpiece W on the upstream side of the conveyance roller 25. The workpiece guide 24 changes the conveyance direction of the workpiece W from the upward direction to the forward direction and conveys the workpiece W into the printing area 12.

The conveyance roller 25 is a roller that generates a conveying force for intermittently feeding the workpiece W in the printing area 12. The conveyance roller 25 is rotationally driven around the shaft by a second motor M2, and intermittently conveys the workpiece W in the forward direction (predetermined conveyance direction F) so that the workpiece W passes through the printing area 12 (image forming position) facing the carriage 3. The pinch roller 26 is disposed to face the conveyance roller 25 from above, and forms a conveyance nip portion with the conveyance roller 25.

The return roller 27 changes the conveyance direction of the workpiece W that has passed through the printing area 12 from the forward direction to the downward direction, and guides the workpiece W after the printing processing to the winding roller 22. The second tension roller 28 applies a predetermined tension to the workpiece W on the downstream side of the conveyance roller 25. A platen 29 is disposed below the conveyance path of the workpiece W in the printing area 12.

The carriage 3 reciprocates in the main scanning direction S (in the present embodiment, the left-right direction) that intersects (in the present embodiment, is orthogonal to) the conveyance direction F in a state of being cantilevered by the guide rails 17. The carriage 3 includes a carriage frame 30, and the ink head 4, the pre-processing head 5, the post-processing head 6, and the sub-tank 7 which are mounted on the carriage frame 30. The carriage frame 30 includes a head support frame 31 and a back frame 32.

The head support frame 31 is a horizontal plate holding the above-described heads 4 to 6. The back frame 32 is a vertical plate extending upward from a rear end edge of the head support frame 31. As described above, the timing belt 16 is fixed to the back frame 32. The guide rails 17 are engaged with the back frame 32. That is, in the present embodiment, the back frame 32 is an engagement portion held by the guide rails 17 in a cantilever state. The head support frame 31 is a horizontal plate whose rear end side is supported on the guide rails 17 in a cantilever manner by the engagement portion.

The cantilever state indicates a state in which an engagement portion (back frame 32) which is a portion held by the guide rails 17 which are holding members exists only on one side of the upstream side or the downstream side from the center of the carriage 3 in the conveyance direction F in the carriage 3, and another engagement portion does not exist on the side opposite to the side on which the engagement portion exists. The engagement portion may be disposed outside the range where the ink head 4 and the processing head are disposed in the conveyance direction F. That is, the engagement portion may be disposed only on the upstream side or only on the downstream side in the conveyance direction F with respect to the range in which the ink head 4 and the processing head are disposed.

### Details of Carriage

The carriage 3 will be further described. FIG. 3 is an enlarged perspective view of the carriage 3 illustrated in FIG. 1. FIG. 3 illustrates the conveyance direction F (sub scanning direction) of the workpiece W and a main scanning direction S that is a movement direction of the carriage 3. FIG. 3 illustrates an example in which a plurality of the ink heads 4 that discharge ink for image formation onto the workpiece W, the pre-processing head 5 and the post-processing head 6 that discharge non-color-developing processing liquid, and a plurality of the sub-tanks 7 that supply the ink and the processing liquid to these heads 4 to 6 are mounted on the carriage 3.

Each of the ink heads 4 includes a large number of nozzles (ink discharge holes) for discharging ink droplets by a discharge method such as a piezoelectric method using a piezoelectric element or a thermal method using a heating element, and an ink passage for guiding ink to the nozzles. As the ink, for example, an aqueous pigment ink containing an aqueous solvent, a pigment, and a binder resin can be used. The plurality of ink heads 4 in the present embodiment are each capable of discharging eight colors of ink. The ink heads 4 are mounted on the head support frame 31 of the carriage 3 so as to be arranged in two columns in the main scanning direction S. The ink head 4 for each color has two heads. The arrangement of the ink heads 4 will be described in detail below.

The pre-processing head 5 and the post-processing head 6 are disposed at positions different from the ink head 4 in the conveyance direction F. The pre-processing head 5 is disposed on the upstream side of the ink head 4 in the conveyance direction F. FIG. 3 illustrates an example in which one pre-processing head 5 is disposed near the left end of an array of the ink heads 4. Similarly, the post-processing head 6 is disposed on the downstream side of the ink head 4 in the conveyance direction F. FIG. 3 illustrates an example in which one post-processing head 6 is disposed at the right end of the array of the ink heads 4. In another embodiment, a plurality of the pre-processing heads 5 or a plurality of the post-processing heads 6 may be disposed. That is, the carriage 3 is provided with at least one pre-processing head 5 and at least one post-processing head 6. In another embodiment, the pre-processing head 5 and the post-processing head 6 may not be disposed.

In addition, a series of heads along the main scanning direction S, which is configured by the ink head 4, the pre-processing head 5, and the post-processing head 6, is referred to as a column of heads or simply as a column. A series of heads along the conveyance direction F, which is configured by the ink head 4, the pre-processing head 5, and the post-processing head 6, is referred to as a row of heads or simply a row.

The pre-processing head 5 discharges the pre-processing liquid for applying predetermined pre-processing to the workpiece W. The pre-processing liquid is discharged from the pre-processing head 5 to a position of the workpiece W to which the ink has not been discharged from the ink head 4. The pre-processing liquid is a non-color-developing processing liquid that does not develop a color even when adhering to the workpiece W, and is processing liquid exhibiting, for example, a function of enhancing the fixability of the ink to the workpiece W and/or the aggregation property of an ink pigment. As such pre-processing liquid, processing liquid in which a binding resin is blended in a solvent, processing liquid in which a cationic resin positively charged is blended in a solvent, or the like can be used.

The post-processing head 6 discharges a post-processing liquid for applying predetermined post-processing to the workpiece W to which the ink has adhered. The post-processing liquid is discharged from the post-processing head 6 to a position of the workpiece W after the ink is discharged from the ink head 4. Similarly, the post-processing liquid is a non-color-developing processing liquid that does not develop a color even when adhered to the workpiece W, and is a processing liquid that exhibits a function of enhancing the fixability and robustness (resistance to rubbing and scraping) of the ink image printed on the workpiece W by the ink head 4. As such a post-processing liquid, a silicone-based processing liquid or the like can be used. Note that the post-processing liquid and the pre-processing liquid are different processing liquids. Specifically, components contained in the post-processing liquid are different from those contained in the pre-processing liquid.

Here, the non-color-developing processing liquid refers to processing liquid that is not recognized by a person by the naked eye as having developed color when printed alone on the recording medium. Here, the color includes a color having a saturation of 0, such as black, white, and gray. The non-color-developing processing liquid is basically a transparent liquid, but for example, when one liter of the processing liquid is viewed in a liquid state, the non-color-developing processing liquid may not be completely transparent and may appear slightly white or the like. Since such a color is very light, a person cannot recognize that the color is developed by the naked eye when the color is printed alone on the recording medium. Depending on the type of processing liquid, when printed alone on the recording medium, there may be changes in the recording medium such as a glossy appearance, but such a state is not considered to be color development.

In the present embodiment, the pre-processing liquid and the post-processing liquid may be discharged onto substantially the entire surface of the workpiece W, or the pre-processing liquid and the post-processing liquid may be selectively discharged in accordance with the image to be printed, similarly to the ink.

A case where the pre-processing liquid and the post-processing liquid are selectively discharged will be described. As described above, the pre-processing liquid, the ink, and the post-processing liquid are discharged in this order onto the workpiece W in the portion where the color is printed in accordance with the image. In this case, the ink may have one color or a plurality of colors. Basically, neither the pre-processing liquid nor the post-processing liquid is discharged to a portion where no color is printed, that is, a portion where no ink is discharged. In addition, in order to adjust the image quality of the image to be printed, the texture of the workpiece W, or the like, a part of the selection of the discharge of the pre-processing liquid and the post-processing liquid may be different from that of the discharge of the ink.

As illustrated in FIG. 3, an opening 31H is provided at a position of the head support frame 31 where the head is disposed. The ink head 4, the pre-processing head 5, and the post-processing head 6 are assembled to the head support frame 31 so as to be fitted into each opening 31H. Nozzles disposed on the lower end surfaces of the heads 4, 5, and 6 are exposed from each opening 31H.

The sub-tank 7 is supported by the carriage 3 above the heads 4, 5, and 6 via a holding frame (not illustrated). The sub-tank 7 is provided corresponding to each of the heads 4, 5, and 6. Each sub-tank 7 is supplied with the ink or the processing liquid from a cartridge or a main tank (not illustrated) in which the ink and the processing liquid are accommodated, and supplies the ink or the processing liquid to each of the heads 4, 5, and 6. Each of the sub-tanks 7 and the heads 4, 5, and 6 are connected by a pipe line (not illustrated in FIG. 3).

As described above, in the present embodiment, the ink jet printer 1 is an all-in-one-type printer in which three types of heads of the ink heads 4, the pre-processing head 5, and the post-processing head 6 are mounted on one carriage 3. According to the ink jet printer 1, for example, in printing processing in which ink jet printing is performed on a fabric in digital textile printing, the discharge processing of the pre-processing liquid and the discharge process of the post-processing liquid can be integrally executed. Thus, the printing processing can be simplified and the printing device can be made compact.

### Printing Method

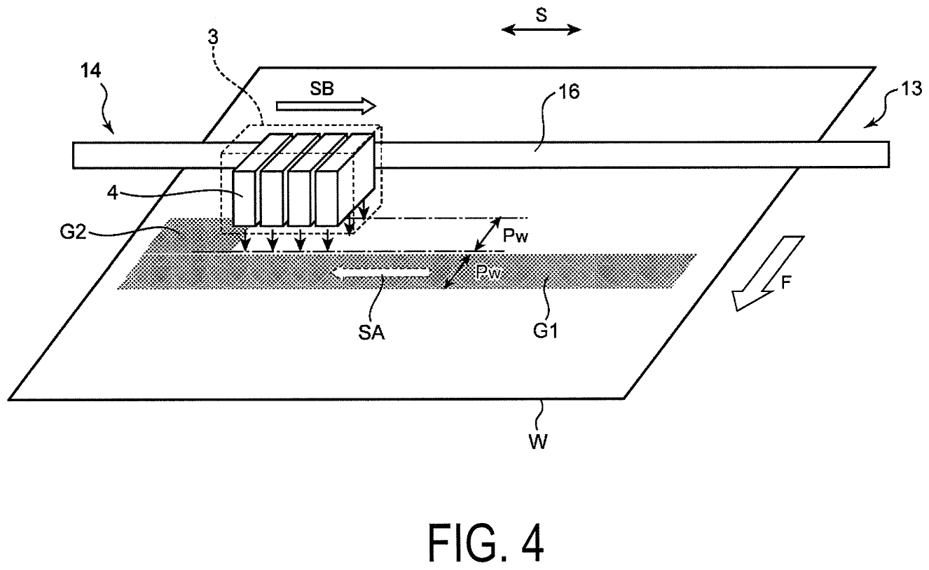

A printing method executed by the ink jet printer 1 according to the present embodiment will be described. The ink jet printer 1 performs printing processing on the workpiece W by a serial printing method. FIG. 4 is a schematic diagram illustrating the serial printing method. In FIG. 4, the carriage 3 is illustrated in a simplified manner by omitting the pre-processing head 5 and the post-processing head 6.

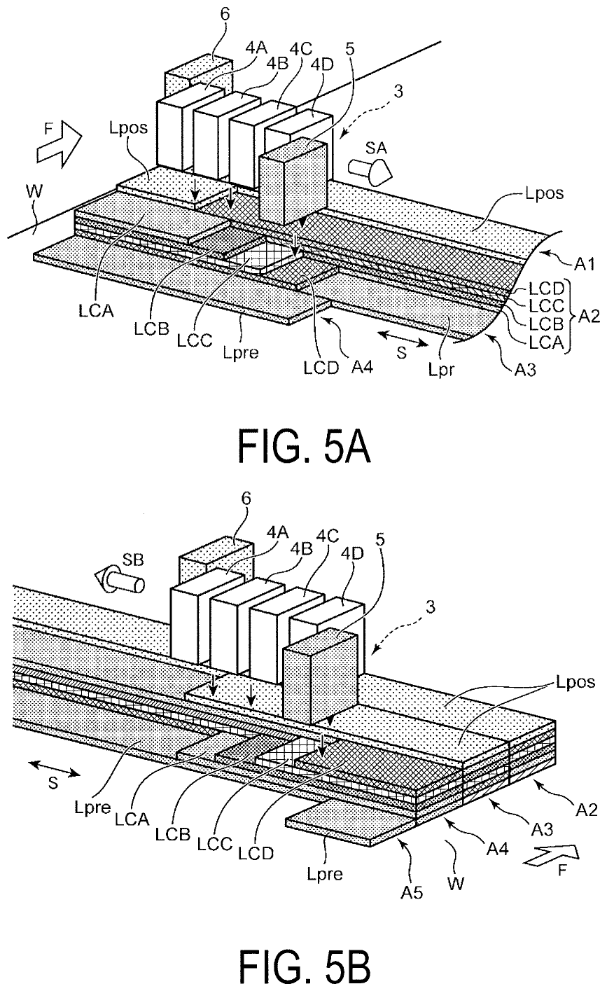

When the workpiece W has a wide size, printing cannot be performed while the workpiece W is continuously fed. The serial printing method is a printing method in which reciprocating movement of the carriage 3 on which the ink heads 4 of the respective colors are mounted in the main scanning direction S and intermittent feeding of the workpiece W in the conveyance direction F are repeated. Here, it is assumed that the ink head 4 has a predetermined printing width Pw in the conveyance direction F. The printing width Pw is substantially equal to the length in the conveyance direction F of the region where the ink discharge nozzles of the ink head 4 are disposed. In FIG. 4 and FIG. 5A and FIG. 5B which will be described next, the length of each of the heads in the conveyance direction F and the printing width Pw are drawn to be substantially equal, but in practice, the length of the head in the conveyance direction F is larger than the printing width Pw and the length of the discharge nozzle arrangement region in the conveyance direction F.

FIG. 4 illustrates a state in which the carriage 3 has moved in a forward path direction SA in the main scanning direction S, and the printing of a band-like image G1 with the printing width Pw has been completed. During the main scanning in the forward path direction SA, the feeding of the workpiece W is stopped. After the printing of the band-like image G1, the workpiece W is fed in the conveyance direction F by a pitch corresponding to the printing width Pw. At this time, the carriage 3 stands by in the return area 14 on the left end side. After the workpiece W is fed out, the carriage 3 turns back in a backward path direction SB in accordance with the reverse movement of the timing belt 16. The workpiece W is in a stopped state. Then, as illustrated in FIG. 4, the carriage 3 prints the band-like image G1 having the printing width Pw on the upstream side of a band-like image G2 while moving in the backward path direction SB. Thereafter, the same operation is repeated.

FIG. 5A and FIG. 5B are schematic diagrams illustrating a printing state in the forward path and the backward path of the carriage 3. Here, the ink head 4, the pre-processing head 5, and the post-processing head 6 mounted on the carriage 3 are illustrated in a simplified manner. The ink head 4 includes first, second, third, and fourth ink heads 4A, 4B, 4C, and 4D for discharging inks of first, second, third, and fourth colors different from each other, and the first to fourth ink heads 4A to 4D are arranged in a column in the main scanning direction S. The pre-processing head 5 and the post-processing head 6 are disposed on the upstream side and the downstream side, respectively, of the ink head 4 in the conveyance direction F. As in the case described with reference to FIG. 4, the workpiece W is fed in the conveyance direction F between the printing of the forward path and the printing of the backward path. The moving distance in the conveyance direction F at this time is an interval pitch (head pitch) between the heads adjacent to each other in the conveyance direction F. This moving distance is also the printing width Pw of each of the heads 4, 5, and 6.

FIG. 5A illustrates a state in which the printing operation is performed while the carriage 3 moves in the forward path direction SA in the main scanning direction S (forward path main scanning). The region A4 on the workpiece W faces the pre-processing head 5 mounted on the most upstream side of the carriage 3. In the current forward path main scanning, a pre-processing layer Lpre is formed on the region A4 by the pre-processing liquid discharged from the pre-processing head 5.

The region A3 is a region on the downstream side of the region A4 by one head pitch, and faces the ink head 4. On the region A3, the pre-processing layer Lpre has already been formed over the entire length in the main scanning direction by the previous backward path main scanning. In the current forward path main scanning, first, second, third, and fourth ink layers LCA, LCB, LCC, and LCD are formed on the pre-processing layer Lpre of the region A3 by the first to fourth color inks sequentially discharged in the arrangement order of the first to fourth ink heads 4A to 4D. In FIG. 5A, in order to facilitate understanding, the fourth to first ink layers LCD to LCA are illustrated so as to be sequentially stacked, and are not actually stacked. The above-described pre-processing layer Lpre and the after-mentioned post-processing layer Lpos are not formed on the workpiece W.

The region A2 is a region on the downstream side by one head pitch from the region A3, and faces the post-processing head 6 mounted on the most downstream side of the carriage 3. On the region A2, the pre-processing layer Lpre formed by the previous forward path main scanning and the first to fourth ink layers LCA to LCD formed by the previous backward path main scanning are already formed over the entire length in the main scanning direction. In the current forward path main scanning, the post-processing layer Lpos is formed on the first to fourth ink layers LCA to LCD of the region A2 by the post-processing liquid discharged from the post-processing head 6.

The region A1 is a region on the downstream side of the region A2 by one head pitch, and is a region where the carriage 3 has passed and the printing processing has been completed. That is, in the region A1, the pre-processing layer Lpre, the first to fourth ink layers LCA to LCD, and the post-processing layer Lpos are formed over the entire length in the main scanning direction.

FIG. 5B illustrates a state in which, after the forward path main scanning of FIG. 5A is finished, the carriage 3 turns back and performs the backward path main scanning while moving in the backward path direction SB. Before the turn-back movement, the workpiece W is fed in the conveyance direction F by one head pitch. The region A5 on the workpiece W is a region on the upstream side by one head pitch from the region A4, and faces the pre-processing head 5 in the current backward path main scanning. The pre-processing layer Lpre is formed on the region A5 by the pre-processing liquid discharged from the pre-processing head 5.

In the region A4 and the region A3, the first to fourth ink layers LCA to LCD and the post-processing layer Lpos are formed on existing layers, respectively. To be specific, in the region A4, the first to fourth ink layers LCA to LCD are formed on the pre-processing layer Lpre. In the region A3, the post-processing layer Lpos is formed on the first to fourth ink layers LCA to LCD. The region A2 is a region in which the printing processing is completed, following the region A1.

The reason why the printing processing can be performed in both the forward path main scanning and the backward path main scanning as described above is that the pre-processing head 5 and the post-processing head 6 are disposed to be shifted in the conveyance direction F with respect to the ink head 4. If the pre-processing head 5, the ink head 4, and the post-processing head 6 are arranged in a column in this order in the main scanning direction S in the carriage 3, the printing processing in which the pre-processing liquid and the post-processing liquid can be deposited in a desired order can be realized only in one of the forward path main scanning and the backward path main scanning. In order to be able to perform printing processing in both directions, a pair of pre-processing heads 5 and post-processing heads 6 are disposed on each side of the array of ink heads 4. In this case, the length of the carriage 3 in the main scanning direction S is increased. Since such an arrangement is not necessary in the present embodiment, the length of the carriage 3 in the main scanning direction S can be reduced.

When the ink heads 4 are disposed in a plurality of columns, the amount of ink deposited on the workpiece W can be increased. For example, when there are two columns of the ink heads 4, printing can be performed as follows. After the first to fourth ink layers LCA to LCD are formed as described above by the ink heads 4 in the first column, the workpiece W is conveyed in the conveyance direction F by one head pitch, and the first to fourth ink layers LCA to LCD are formed by the ink heads 4 in the second column. In this manner, printing of an amount of ink corresponding to two layers on the workpiece W can be performed.

### Arrangement of Heads

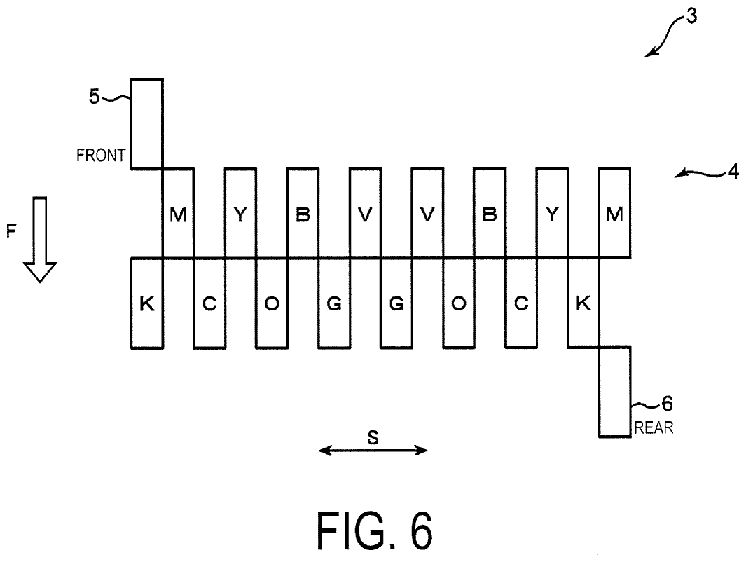

FIG. 6 is a plan view schematically illustrating the arrangement of the ink head 4 and the processing heads 5 and 6 on the carriage 3 illustrated in FIG. 3. As described above, the carriage 3 is supported in a cantilever state by the guide rails 17 in the back frame 32 (FIG. 3). The back frame 32 is disposed on the upstream side of the head support frame 31 in the conveyance direction F. In the conveyance direction F, a side of the head support frame 31 on which the back frame 32 is disposed is referred to as a base end side, and a side of the head support frame 31 opposite to the base end side is referred to as a tip end side. As described above, the plurality of ink heads 4 that discharge eight colors of ink, the pre-processing head 5, and the post-processing head 6 are mounted on the head support frame 31 of the carriage 3. The ink head 4 of each color includes two unit heads. The two ink heads 4 that discharge ink of the same color are referred to as same-color ink heads, and a group of the two same-color ink heads is referred to as a same-color ink head group.

In FIG. 6, each of the sixteen ink heads 4 in total is labeled with an alphabet letter corresponding to the color of the ink to be discharged. More specifically, K means black, Y means yellow, M means magenta, C means cyan, B means blue, V means violet, O means orange, and G means green. In addition, “pre” is written for the pre-processing head 5, and “post” is written for the post-processing head 6.

As illustrated in FIG. 6, the pre-processing head 5 is disposed upstream of the plurality of ink heads 4 in the conveyance direction F, and the post-processing head 6 is disposed downstream of the plurality of ink heads 4 in the conveyance direction F. The pre-processing head 5 is disposed at an end (left end) in the main scanning direction S of the arrangement range in which the plurality of ink heads 4 are disposed. On the other hand, the post-processing head 6 is disposed at an end (right end) in the main scanning direction S on the opposite side to the pre-processing head 5 in the arrangement range in which the plurality of ink heads 4 are disposed. As a result of the above-described head arrangement, the pre-processing head 5 and the post-processing head 6 are disposed within the range of the arrangement width of the ink head 4 in the main scanning direction S.

The plurality of ink heads 4 are mounted on the carriage 3 so as to form two (a plurality of) ink head columns each extending along the main scanning direction S and arranged side by side in the sub scanning direction (the conveyance direction F) intersecting the main scanning direction S. As a result, the width of the carriage 3 in the main scanning direction S can be reduced while a large number of ink heads 4 are disposed. The respective ink heads 4 of colors M, Y, B, and V are disposed on the side close to the pre-processing head 5, that is, in the ink heads 4 of the first column on the upstream side in the conveyance direction F. A pair of ink heads 4 of color M is disposed on the outermost side in the main scanning direction S, and similarly, a pair of ink heads 4 of color Y, a pair of ink heads 4 of color B, and a pair of ink heads 4 of color V are disposed in order on the inner side in the main scanning direction S. In other words, the ink heads 4 of the four colors are disposed symmetrically in the main scanning direction S.

The respective ink heads 4 of colors K, C, O, and G are disposed on the side close to the post-processing head 6, that is, the ink heads 4 of the second column on the downstream side in the conveyance direction F. A pair of ink heads 4 of color K is disposed on the outermost side in the main scanning direction S, and similarly, a pair of ink heads 4 of color C, a pair of ink heads 4 of color O, and a pair of ink heads 4 of color G are disposed in order on the inner side in the main scanning direction S. In other words, the ink heads 4 of the four colors are also disposed symmetrically in the main scanning direction S.

In addition, as illustrated in FIG. 6, the ink heads 4 in the first column and the ink heads 4 in the second column are disposed so as to be shifted from each other in the main scanning direction S, and the ink heads 4 in one column are disposed between the adjacent ink heads 4 in the other column, so that the ink heads 4 in the first column and the ink heads 4 in the second column are disposed in a staggered manner as a whole. The pre-processing head 5 is disposed behind the ink head 4 of color K on the left side of the second column, and the post-processing head 6 is disposed in front of the ink head 4 of color M on the right side of the first column.

Unless otherwise specified, in the drawings including FIG. 6, the intervals between the heads adjacent to each other in the main scanning direction S (intervals between the centers of the heads) are the same as each other. Similarly, the intervals between the heads adjacent to each other in the conveyance direction F (the intervals between the centers of the heads) are the same as each other.

In the present embodiment, two ink heads 4 that discharge ink of the same color (same-color ink heads) are disposed in the same column. In other words, the ink head 4 of each color is disposed in one ink head column of the two ink head columns and is not disposed in the other ink head column. As a result, when the carriage 3 reciprocates in the main scanning direction, ink can be discharged from the two ink heads 4 to a predetermined pixel during scanning in the same direction. Therefore, as compared with the case where the two ink heads 4 are disposed separately in different columns, the difference in the time to impact of the ink on the pixels can be reduced, and a stable image can be formed.

To additionally describe the above, if the two ink heads 4 of the color K are disposed in the first column and the second column, respectively, a difference occurs in the time interval of deposition of the inks discharged from the two ink heads 4 between the case of reciprocating after scanning in the right direction and the case of reciprocating after scanning in the left direction with respect to the same pixel. In particular, when the time interval is increased, the ink may be colored too deeply. In the present embodiment, such a problem can be solved by collectively arranging the ink heads 4 of the same color in one column.

As illustrated in FIG. 6, the two ink heads 4 for discharging the same color ink for each color are disposed symmetrically in the main scanning direction S, more specifically, symmetrically on the left and right sides with respect to a center line extending in the conveyance direction F at the central portion in the main scanning direction S. Therefore, even in a case where the carriage 3 performs scanning in any direction of the right direction and the left direction, it is possible to make the deposition order of the ink of each color the same and to reduce the difference in the time to impact of each color, and the occurrence of a partial difference in color on the workpiece W can be suppressed. Note that, when the sixteen ink heads 4 are disposed in a line in a bilaterally symmetrical manner as described above, the distribution of the difference in the time to impact of each color (variation between colors) becomes large.

In the present embodiment, the two ink heads 4 (black ink head group) that discharge black ink are disposed at both ends in the main scanning direction S. Therefore, the density of the black color can be increased on the workpiece W. In contrast to the color of the material constituting the workpiece W, the black color is more difficult to express than the other colors. Since black does not reflect light, if the reflection of the color of the material remains, it becomes difficult to express a pure black color by that amount. In the present embodiment, by disposing the black ink heads 4 at both end portions, the time to impact from the two ink heads 4 with respect to a predetermined pixel can be increased and the density can be increased. As a result, the printing quality can be improved. When the ink is a pigment-based ink, it is difficult to completely cover the fabric with the pigment, and thus the density is preferably increased by using such a difference in time to impact.

In particular, in the present embodiment, the black ink head 4 is disposed in a column on the downstream side (most downstream side) in the conveyance direction F. Therefore, since the black ink is deposited relatively later, the density of the black ink can be further increased. When the ink heads 4 are disposed in three or more columns, it is desirable that the black ink head 4 be disposed on the more downstream side in the conveyance direction F, and it is more desirable that the black ink head 4 be disposed on the most downstream side.

In the present embodiment, as illustrated in FIG. 6, the ink heads 4 of black, cyan, magenta, and yellow (basic-color ink heads) are disposed outside the ink heads 4 of the other colors (non-basic-color ink heads) in the main scanning direction S. Therefore, the color development of the basic colors can be improved by disposing the ink heads 4 of not only black but also the basic colors for which color development is emphasized on both sides in the main scanning direction S and increasing the time difference of deposition.

The ink heads 4 of these basic colors are used relatively frequently. Therefore, by disposing the ink heads 4 at positions on the carriage 3 where the ink heads 4 are not densely disposed and have high heat dissipation, such as both end portions in the main scanning direction S, the increase in the temperature of each ink head 4 can be suppressed. The amount of heat generation can be dispersed by distributing and positioning the ink heads 4 generating a large amount of heat at two positions on both sides in the main scanning direction S.

In the present embodiment, as illustrated in FIG. 6, the black ink heads 4 and the yellow ink heads 4 are disposed in different columns. If the black ink and the yellow ink are mixed in a state close to a liquid state before the inks permeate and are fixed to the workpiece W, it may be difficult to obtain good image quality. Therefore, by disposing black and yellow in different columns, the mixing as described above can be suppressed and the stable image quality can be obtained. Such a configuration can be achieved by disposing the ink heads 4 in a plurality of columns as in the present embodiment.

In the present embodiment, the ink head 4 of yellow and the ink heads 4 of inks (green and orange) having hues close to yellow are disposed in different columns. As a result, in the same manner as described above, the mixing of these inks having similar hues can be suppressed.

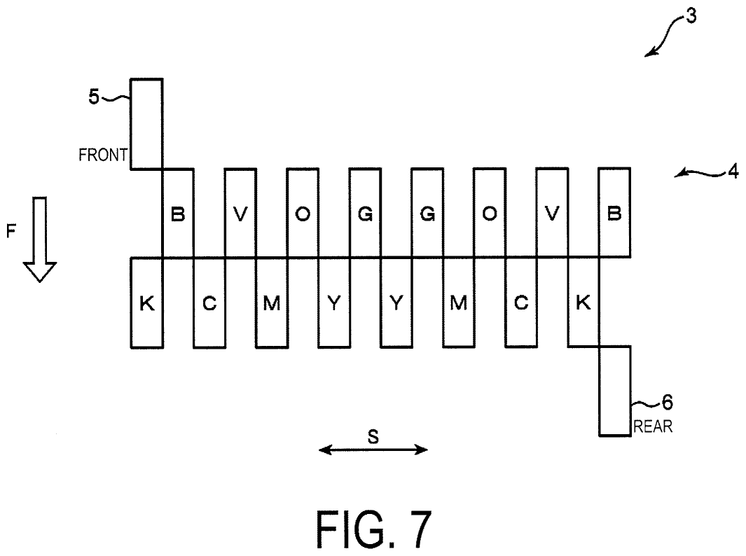

Note that the present disclosure is not limited to the above-described embodiments, and may take the following forms.
(1) The ink heads 4 are not limited to those disposed in two columns in the carriage 3. The ink heads 4 may be disposed in three or more columns.
(2) In the example illustrated in FIG. 6, the two ink heads 4 are disposed in the same column for all the colors, but the two ink heads 4 may be separately disposed in each column for ink of a color whose color development property is less likely to be affected by the time interval of deposition.
(3) FIG. 7 is a schematic plan view illustrating the arrangement of ink heads and processing heads on a carriage according to a first modified embodiment of the present disclosure. The ink colors are displayed in the same manner as in FIG. 6 (the same applies to the other figures described later). In this modified embodiment, the plurality of ink heads 4 include a plurality of basic-color ink heads that respectively discharge inks of basic colors (K, C, M, and Y) that are any of black, cyan, magenta, and yellow, and a plurality of non-basic-color ink heads that respectively discharge inks of colors (B, V, O, and G) other than the basic colors. The basic-color ink heads are disposed in a column on the downstream side in the conveyance direction F in the column of the plurality of ink heads 4.

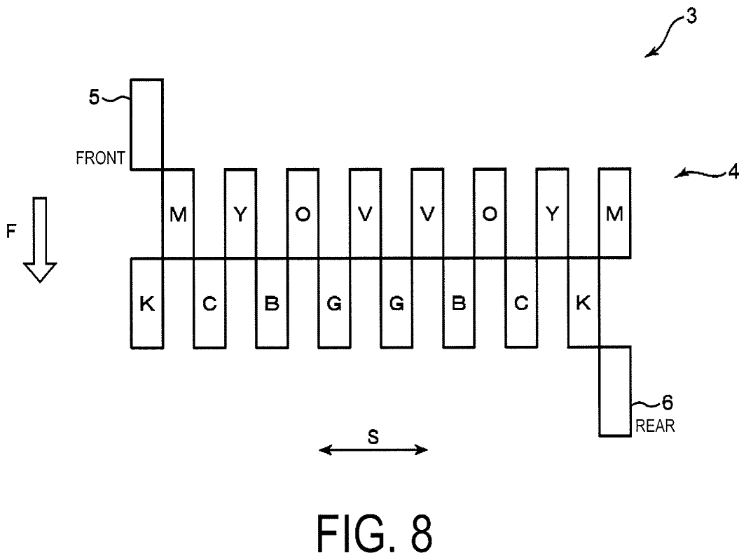

According to such an arrangement, since the ink of the respective colors discharged from the ink heads 4 of the basic colors are deposited relatively later, the color development of the basic colors can be improved. As in the above-described embodiment, the black ink heads 4 are disposed at both ends in the main scanning direction S, so that the density of black can be further increased. The color development can be further improved by keeping yellow, which tends to have a poor color when mixed with black, farthest from black.
(4) FIG. 8 is a schematic plan view illustrating an arrangement of ink heads and processing heads on a carriage according to a second modified embodiment of the present disclosure. In this modified embodiment, the ink head 4 that discharges ink of a color closest to cyan in a hue among the plurality of ink heads 4 is disposed in a column on the downstream side in the conveyance direction F among the plurality of ink head columns. Specifically, two ink heads 4 for cyan are disposed in the second column. Similarly, the ink heads 4 for the second and subsequent colors having hues close to cyan among the plurality of ink heads 4 are preferably disposed in the second column (the column on the downstream side in the conveyance direction F). In FIG. 8, blue corresponds to the color second closest to cyan.

When the colors of the inks discharged from the plurality of ink heads 4 are arranged in order of hue from closest to cyan, and half of the inks closer to cyan are cyan-based inks, and the remaining half of the inks are non-cyan-based inks, it is desirable that half or more of the inks disposed in the column on the downstream side in the conveyance direction among the plurality of ink head columns are set to the cyan-based inks. In FIG. 8, cyan, blue, and green correspond to the cyan-based ink, and correspond to half or more of the ink heads 4 in the second column.

According to such a configuration, the color development of the cyan-based ink can be improved by depositing the cyan-based ink, which tends to develop a relatively dark color even with the same amount of ink, later.

In the above description, the inks are classified based on cyan. However, in another embodiment, the inks may be classified based on red. In this case, it is desirable that the ink head 4 that discharges ink of a color closest to red in a hue among the plurality of ink heads 4 be disposed in a column on the upstream side in the conveyance direction F among the plurality of ink head columns. Specifically, in FIG. 8, two ink heads 4 for magenta are disposed in the first column. Similarly, the ink heads 4 for the second and subsequent colors having hues close to red among the plurality of ink heads 4 are preferably disposed in the first column (the column on the upstream side in the conveyance direction F). In FIG. 8, violet corresponds to the color second closest to red.

When the colors of the inks discharged from the plurality of ink heads 4 are arranged in order of hue from closest to red, and a half of the inks closer to red are set as the red-based inks, and the remaining half of the inks are set as the non-red-based inks, it is desirable that half or more of the inks disposed in the column on the upstream side in the conveyance direction F among the plurality of ink head columns are set as the red-based inks. In FIG. 8, magenta, orange, and violet correspond to the red-based inks, and correspond to more than half of the ink heads 4 in the first column.

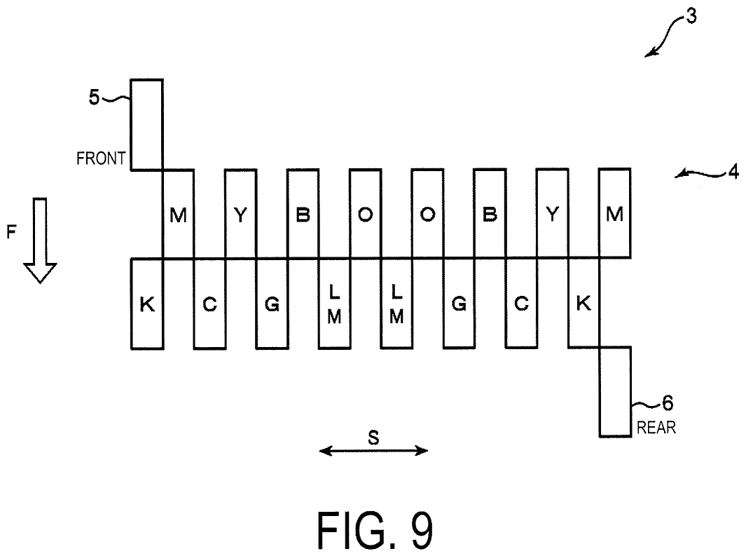

According to such a configuration, by depositing the red-based ink first and relatively suppressing the color development, the overall color development including the cyan-based ink can be improved.
(5) FIG. 9 is a schematic plan view illustrating the arrangement of ink heads and processing heads on a carriage according to a third modified embodiment of the present disclosure. In this modified embodiment, the ink head 4 (second ink head) of LM (light magenta, second ink) is disposed on the innermost side (central portion) in the main scanning direction S among the ink heads 4 of the second column. On the other hand, the ink head 4 (first ink head) that discharges magenta ink (first ink) is disposed in the first column. Light magenta has a hue similar to that of magenta and has a relatively high lightness. By including such a light ink, the color expression range (color space) can be expanded.

Here, after the ink of light magenta which develops a color lighter than a color of magenta has been deposited on the workpiece W, if another ink is deposited on the same pixel, the color development of light magenta is likely to be impaired due to the influence thereof. Therefore, in the present modified embodiment, the light magenta is disposed in the second column, which makes it possible to reduce the influence of subsequent ink deposition.

As illustrated in FIG. 9, the ink head 4 that discharges the light magenta ink is disposed on the inner side (central portion) in the main scanning direction S. As a result, by reducing the time to impact of the inks discharged from the two ink heads 4, the light magenta ink can be colored thinly, and the color gamut on the workpiece W can be expanded.

The light ink is not limited to the light magenta ink described above. In other embodiments, inks such as light cyan and light yellow may be used, and gray ink may be used as the black light-based ink. Even in this case, the color development of the light ink can be maintained by disposing the light ink having a relatively light color development in the second column (on the downstream side in the conveyance direction F). Here, black and gray are considered to have similar hues in the sense that they do not exhibit a specific hue.
(6) In each of the above-described embodiments, the appropriate arrangement of the ink heads 4 has been described by focusing on the color of the ink, but the present disclosure is not limited thereto. When the plurality of ink heads 4 include a first ink head that discharges first ink and a second ink head that discharges second ink having a pigment content higher than a pigment content of the first ink, the second ink head is preferably disposed in a column on the downstream side of the first ink head in the conveyance direction F in the plurality of ink head columns.

In general, an ink having poor color development property tends to contain a relatively large amount of a pigment in order to compensate for the color development property. However, the content of the pigment is limited due to other characteristics required for the ink. Therefore, by disposing the ink head 4 that discharges such ink on the downstream side in the conveyance direction F where the color development property is high, the color development property can be covered.

Similarly, when the plurality of ink heads 4 include a first ink head that discharges first ink and a second ink head that discharges second ink having a binder content higher than a binder content of the first ink, the second ink head is preferably disposed in a column on the downstream side of the first ink head in the conveyance direction F in the plurality of ink head columns.

Ink having poor color development property tends to contain a relatively large amount of a binder in order to compensate for the color development property. However, since the content of the binder is also limited due to other characteristics required for the ink, the color development property can be further covered by disposing the ink head 4 which discharges such ink on the downstream side in the conveyance direction F where the color development property is high.

In the carriage 3 having the pre-processing head 5 and the post-processing head 6 as in the above-described embodiment, the ink heads 4 may be disposed as follows. Specifically, when the plurality of ink heads 4 include a first ink head that discharges first ink and a second ink head that discharges second ink having a pigment content higher than a pigment content of the first ink, the second ink head may be disposed in a column on the upstream side of the first ink head in the conveyance direction F in the plurality of ink head columns.

According to such an arrangement, after the pre-processing liquid has landed on a predetermined pixel on the workpiece W, the second ink can be deposited on the pixel at a relatively early stage. Therefore, the time for fixing the second ink before the post-processing liquid is deposited on the pixels and permeates into the material of the workpiece W can be lengthened. As a result, the fixation of the ink (second ink) having a large amount of pigment to the workpiece W can be improved and the durability of the printed matter can be improved.

Similarly, when the plurality of ink heads 4 include a first ink head that discharges first ink and a second ink head that discharges second ink having a binder content higher than a binder content of the first ink, the second ink head may be disposed in a column on the upstream side of the first ink head in the conveyance direction F in the plurality of ink head columns.

Also in such a head arrangement, for the same reason as described above, the fixation of the ink (second ink) containing a large amount of binder to the workpiece W can be improve and the durability of the printed matter can be improved.

### REFERENCE SIGNS

1 Ink jet printer (recording apparatus)
3 Carriage
4 Ink head
5 Pre-processing head
6 Post-processing head
7 Sub-tank
10 Device frame
12 Printing area
13 Maintenance area
14 Return area
20 Workpiece conveying portion
H Head arrangement region
W Workpiece

1. A printing unit comprising:
a carriage configured to reciprocate in a main scanning direction; and
a plurality of ink heads configured to discharge ink, wherein
the plurality of ink heads are mounted on the carriage to form a plurality of ink head columns, each of the plurality of ink head columns extending along the main scanning direction, the plurality of ink head columns being arranged side by side in a sub scanning direction intersecting with the main scanning direction,
the plurality of ink heads comprise a plurality of same-color ink head groups, each of the plurality of same-color ink head groups comprising a plurality of same-color ink heads configured to discharge ink of the same color, and
in at least one same-color ink head group of the plurality of same-color ink head groups, the plurality of same-color ink heads are disposed in one ink head column of the plurality of ink head columns and are not disposed in the other ink head columns.

2. The printing unit according to claim 1, wherein
in all of the plurality of same-color ink head groups, the plurality of same-color ink heads are disposed in one ink head column of the plurality of ink head columns and are not disposed in the other ink head columns.

3. The printing unit according to claim 1, wherein
the plurality of same-color ink head groups comprise a black ink head group configured to discharge black ink, and
the plurality of same-color ink heads of the black color ink head group are disposed at both end portions of the one ink head column in the main scanning direction.

4. The printing unit according to claim 3, wherein
the plurality of ink heads are configured to discharge ink onto a recording medium conveyed along a conveyance direction parallel to the sub scanning direction, and
the black ink head group is disposed in a column on a downstream side in the conveyance direction among the plurality of ink head columns.

5. The printing unit according to claim 1, wherein
the plurality of ink heads comprise a plurality of basic-color ink heads and a plurality of non-basic-color ink heads, each of the plurality of basic-color ink heads configured to discharge ink of one of basic colors of black, cyan, magenta, and yellow, each of the plurality of non-basic-color ink heads configured to discharge ink of a color other than the basic colors, and
the basic-color ink heads are disposed outside the non-basic-color ink heads in the main scanning direction.

6. The printing unit according to claim 1, wherein
the plurality of ink heads comprise a black ink head configured to discharge black ink and a yellow ink head configured to discharge yellow ink, and
the black ink head and the yellow ink head are disposed in different columns in the plurality of ink head columns.

7. The printing unit according to claim 1, wherein
the plurality of ink heads are configured to discharge ink onto a recording medium conveyed along a conveyance direction parallel to the sub scanning direction, and
an ink head configured to discharge ink of a color closest to cyan in a hue among the plurality of ink heads is disposed in a column on a downstream side in the conveyance direction among the plurality of ink head columns.

8. The printing unit according to claim 1, wherein
the plurality of ink heads are configured to discharge ink onto a recording medium conveyed along a conveyance direction parallel to the sub scanning direction, and
when colors of the ink discharged from the plurality of ink heads are arranged in order of hue from closest to cyan, and half of the inks closer to cyan are defined as cyan-based inks, and the remaining half of the inks are defined as non-cyan-based inks, half or more of the inks disposed in a column on a downstream side in the conveyance direction among the plurality of ink head columns are set as the cyan-based inks.

9. The printing unit according to claim 1, wherein
the plurality of ink heads are configured to discharge ink onto a recording medium conveyed along a conveyance direction parallel to the sub scanning direction, and
an ink head that discharges ink of a color closest to red in terms of hue among the plurality of ink heads is disposed in a column on an upstream side in the conveyance direction among the plurality of ink head columns.

10. The printing unit according to claim 1, wherein
the plurality of ink heads are configured to discharge ink onto a recording medium conveyed along a conveyance direction parallel to the sub scanning direction, and
when colors of the ink discharged from the plurality of ink heads are arranged in an order of hue closest to red, and half of the inks closer to red are defined as red-based inks, and the remaining half of the inks are defined as non-red-based inks, half or more of the inks disposed in a column on an upstream side in the conveyance direction among the plurality of ink head columns are set as the red-based inks.

11. The printing unit according to claim 1, wherein
the plurality of ink heads are configured to discharge ink onto a recording medium conveyed along a conveyance direction parallel to the sub scanning direction,
the plurality of ink heads comprise a first ink head configured to discharge first ink and a second ink head configured to discharge second ink having a hue similar to a hue of the first ink and a high lightness, and
in the plurality of ink head columns, the second ink head is disposed in a column on a downstream side of the first ink head in the conveyance direction.

12. The printing unit according to claim 11, wherein
the second ink head is disposed inside the plurality of ink heads in the main scanning direction.

13. The printing unit according to claim 1, wherein
the plurality of ink heads are configured to discharge ink onto a recording medium conveyed along a conveyance direction parallel to the sub scanning direction,
the plurality of ink heads comprise a first ink head configured to discharge first ink and a second ink head configured to discharge second ink having a pigment content higher than a pigment content of the first ink, and
in the plurality of ink head columns, the second ink head is disposed in a column on a downstream side of the first ink head in the conveyance direction.

14. The printing unit according to claim 1, wherein
the plurality of ink heads are configured to discharge ink onto a recording medium conveyed along a conveyance direction parallel to the sub scanning direction,
the plurality of ink heads comprise a first ink head configured to discharge first ink and a second ink head configured to discharge second ink having a binder content higher than a binder content of the first ink, and
in the plurality of ink head columns, the second ink head is disposed in a column on a downstream side of the first ink head in the conveyance direction.

15. The printing unit according to claim 1, wherein
the plurality of ink heads are configured to discharge ink onto a recording medium conveyed along a conveyance direction parallel to the sub scanning direction,
the printing unit further comprises:
a pre-processing head disposed upstream of the plurality of ink head columns in the conveyance direction and configured to discharge pre-processing liquid; and
a post-processing head disposed downstream of the plurality of ink head columns in the conveyance direction and configured to discharge post-processing liquid,
the plurality of ink heads comprise a first ink head configured to discharge first ink and a second ink head configured to discharge second ink having a pigment content higher than a pigment content of the first ink, and
in the plurality of ink head columns, the second ink head is disposed in a column upstream of the first ink head in the conveyance direction.

16. The printing unit according to claim 1, wherein
the plurality of ink heads are configured to discharge ink onto a recording medium conveyed along a conveyance direction parallel to the sub scanning direction,
the printing unit further comprises:
a pre-processing head disposed upstream of the plurality of ink head columns in the conveyance direction and configured to discharge pre-processing liquid; and
a post-processing head disposed downstream of the plurality of ink head columns in the conveyance direction and configured to discharge post-processing liquid,
the plurality of ink heads comprise a first ink head configured to discharge first ink and a second ink head configured to discharge second ink having a binder content higher than a binder content of the first ink, and
in the plurality of ink head columns, the second ink head is disposed in a column upstream of the first ink head in the conveyance direction.

17. The printing unit according to claim 1, wherein
the plurality of ink heads are configured to discharge ink onto a recording medium conveyed along a conveyance direction parallel to the sub scanning direction,
the plurality of ink heads comprise a plurality of basic-color ink heads and a plurality of non-basic-color ink heads, each of the plurality of basic-color ink heads configured to discharge ink of one of basic colors of black, cyan, magenta, and yellow, each of the plurality of non-basic-color ink heads configured to discharge ink of a color other than the basic colors, and
the basic-color ink heads are disposed in a column on a downstream side in the conveyance direction in the plurality of ink head columns.

18. The printing unit according to claim 1, wherein
the plurality of same-color ink head groups are mounted on the carriage such that colors of the ink discharged by the plurality of same-color ink head groups are symmetrical in the main scanning direction.

19. A recording apparatus comprising:
the printing unit according to claim 1; and
a conveying portion configured to convey a recording medium along a conveyance direction parallel to the sub scanning direction.
